(19) United States
(12) Patent Application Publication
(10) Pub. No.: US 2013/0145867 A1
(43) Pub. Date: Jun. 13, 2013

(54) CONTAMINATION FREE WATER SAMPLER AND SYSTEM

(71) Applicant: Derek Michelin, Plymouth, MA (US)

(72) Inventor: Derek Michelin, Plymouth, MA (US)

(73) Assignee: BATTELLE MEMORIAL INSTITUTE, Columbus, OH (US)

(21) Appl. No.: 13/808,103

(22) PCT Filed: Jul. 28, 2011
(86) PCT No.: PCT/US2011/045755

§ 371 Date: Feb. 13, 2013

Related U.S. Application Data
(60) Provisional application No. 61/369,345, filed on Jul. 30, 2010.

(51) Int. Cl. G01N 1/10

(52) U.S. Cl. CPC G01N 1/10
USPC 73/863.01; 73/864.63

(57) ABSTRACT

A water sampling system, device and method of sampling are provided. Water sampling system includes triggering mechanism, at least one water sampling device and pumping mechanism. Water sampling device is configured to cooperate with triggering mechanism and includes removable sampling container and pinch mechanism. Removable sampling container is disposed in water sampling device and includes inlet, inlet tube and sampling bag attached to inlet tube. Pinch mechanism is located adjacent to and surrounding inlet tube and proximate to sampling bag. Pinch mechanism, when closed, prevents water from entering inlet tube and sampling bag. Pinch mechanism, when open, allows water from inlet into inlet tube and sampling bag. Pumping mechanism creates a flow of water to cause sampling bag to collect water when pinch mechanism is in an open position.

### RELATED APPLICATIONS

This application relates to and claims the benefit of U.S. Provisional Patent Application No. 61/369,345, filed Jul. 30, 2010, entitled “Contamination Free Water Sampler and System,” the disclosure of which is incorporated by reference as if fully rewritten herein.

### BACKGROUND OF THE INVENTION

1. Field of the Invention

The described invention relates in general to water sampling systems, and more specifically to a water sampling system and device that allows for contaminate free water samples.

2. Background Art

A vast majority of subsurface marine water samples are collected using Niskin or Go-Flo bottles. Standard bottles such as Niskin and Go-Flo bottles are deployed individually or on multi-bottle Rosette systems, operate mechanically, and are usually triggered electronically. These standard bottles are open at the top and bottom while lowered through the water column, and are closed at the desired sampling depth. The design of standard sampling bottles creates the potential for contamination when collecting samples in contaminate filled waters. Examples of contaminates include, but are not limited to, high viscosity oil and oil/water emulsions, chemicals, and natural contaminates such as algae. Contaminates will adhere to the inner surfaces of the open standard bottles as the bottles pass through the contaminated layers of the water column, thereby potentially biasing measurements in deeper water with contamination from shallower water. Contamination, while often worst at the surface, can occur at any depth where a contamination source is present. Niskin bottles are open at both ends, and will generally become contaminated as soon as they are lowered through an area containing contaminates. Although Go-Flo bottles can be closed for the first 10 meters of immersion, which can reduce contamination from surface contaminates, this has no effect on contamination from subsurface layers (at or below the 10 meter depth). In addition, Go-Flo bottles use a ball valve which rotates 180° from its initial closed position, to an open position, to a final closed position. This ball valve of the Go-Flo bottle exposes the sample water to the contaminated outer surface of the ball valve in the final, closed position. The ratio of exposed surface area to sample volume for a standard 10 Liter Go-Flo or Niskin bottle with both ends open is approximately 300 cm²/L, which can result in contamination of the water sample.

One challenge with underwater sampling results from the pressure and pressure differentials that are exerted on the sampling containers and contents during submersion and during ascent. The current design of Niskin bottles and Go-Flo bottles provide two open ends to accommodate the pressure difference between the depth at which sampling occurs and the surface; however, as discussed above, these two open ends often lead to contamination of the water sample. Generally, there is an approximately 3068.2 Pascal (Pa) (0.445 pound-force per square inch (psi)) increase of pressure for every foot of seawater below the surface. When a water sample is taken at approximately 304.8 meters (1000 feet), there is approximately an additional 3.45 megapascal (MPa) (500 psi) of pressure as compared to the surface. Deep water applications can be far greater than 304.8 meters (1000 feet) and pressure is proportionately higher.

Another challenge with current underwater sampling equipment results from the potential for cross-contamination from multiple uses of the same sampling container, especially in water that contains contaminants, such as, but not limited to, hydrocarbons, pollution and algae. The current design of Niskin and Go-Flo bottles provides a bottle sampling area made from a durable plastic. Generally, the sampling area of the Niskin and Go-Flo bottles can be adequately washed after each use; however, if the sampled water contains high levels of hydrocarbons, pollution, or algae then the surface of the plastic sampling area can become contaminated and potentially contaminate future samples if the bottle is reused.

Due to these challenges, an ongoing need exists for a system and method for providing contamination free water sampling as an alternative to the use of standard oceanographic Niskin or Go-Flo bottles used in sampling contaminated waters. Yet another need is for a system that will allow the sample area to remain sealed both prior to, and after sampling to eliminate contamination from other layers of water. Still another need is for a system that uses a disposable sample containers to prevent cross-contamination, thereby reducing measurement uncertainty and issues with decontaminating the sampling area. An additional need is for a water sampling system that reduces or minimizes costs associated with water sampling by making the system compatible with existing water sampling equipment. Another additional need is for a system that provides a quicker sampling rate of the water compared to other bag sampling systems. Yet another need is for a system that reduces the possible sources of contamination involved in transferring water from traditional samplers into other sample containers for transportation and storage.

### SUMMARY OF THE INVENTION

The following provides a summary of certain exemplary embodiments of the present invention. This summary is not an extensive overview and is not intended to identify key or critical aspects or elements of the present invention or to delineate its scope.

According to an exemplary embodiment of the invention, a water sampling system including a triggering mechanism, at least one water sampling device and a pumping mechanism is provided. The at least one water sampling device is configured to cooperate with the triggering mechanism. The water sampling device includes a removable sampling container and a pinch mechanism. The removable sampling container is disposed in the water sampling device. The removable sampling container includes an inlet, an inlet tube, and a sampling bag. The inlet tube is attached to the inlet and extends from the inlet. The sampling bag is attached to the inlet tube. The pinch mechanism is adjacent to and surrounds the inlet tube and is proximate to the disposable bag. The pinch mechanism, in a closed position, prevents water from the inlet from entering inlet tube and the disposable bag, and when the pinch mechanism is in an open position, the pinch mechanism allows water from the inlet into the inlet tube and disposable sample bag. The pumping mechanism configured to connect to the water sampling device. The pumping mechanism creates a flow of water in the water sampling device to cause the sampling bag to collect water when the pinch mechanism is in an open position.

According to another exemplary embodiment of the invention, a water sampling device is provided. The water sampling device includes a removable sampling container and a pinch mechanism. The removable sampling container includes an inlet, an inlet tube, and a sampling bag. The inlet tube is configured to cooperate with the inlet and the inlet tube extends from the inlet. The sampling bag is attached to the inlet tube. The pinch mechanism is adjacent to and surrounding the inlet tube, the pinch mechanism is proximate to the disposable bag. The pinch mechanism, in a closed position, prevents water from the inlet from entering the inlet tube and the disposable bag. The pinch mechanism, in an open position, allows water from the inlet into the inlet tube and the sampling bag.

According to another exemplary embodiment of the invention, a method for sampling contaminated water is provided. The method includes providing a water sampling system, lowering the water sampling system to a pre-determined depth, actuating a triggering mechanism to start collecting the water sample, drawing an amount of water though an inlet and an inlet valve into a sampling bag, closing a pinch mechanism, wherein closing the pinch mechanism prevents water from entering or exiting the sampling bag. The water sampling system includes a triggering mechanism and at least one water sampling device attached to the triggering mechanism. The water sampling device includes a removable sampling container and a pinch mechanism. The removable sampling container includes an inlet, an inlet tube, and a sampling bag. The inlet tube is attached to the inlet and extends from the inlet. The sampling bag is attached to the inlet tube. The pinch mechanism is adjacent to and surrounds the inlet tube and is proximate to the sampling bag. The pinch mechanism, in a closed position, prevents water from the inlet from entering inlet tube and the disposable bag, and when the pinch mechanism is in an open position, the pinch mechanism allows water from the inlet into the inlet tube and disposable sample bag. The pumping mechanism configured to connect to the water sampling device. The pumping mechanism creates a flow of water in the water sampling device to cause the sampling bag to collect water when the pinch mechanism is in an open position

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is schematic of an exemplary embodiment of a water sampling device of the present invention, the water sampling device being ready to trigger.

FIG. 2 is schematic of an exemplary embodiment of a water sampling device of the present invention, the water sampling device being triggered.

FIG. 3 is schematic of an exemplary of a water sampling device of the present invention, the water sampling being complete.

FIG. 4 is an enlarged schematic of the water sampling device of FIG. 2.

FIG. 5 is partial perspective cut-out view of the inlet of FIG. 4 taken along line 5-5.

FIG. 6 is a schematic of an exemplary water sampling system of the present invention.

FIG. 7 is a front view of FIG. 6 taken along line 7-7 of the water sampling system of the present invention.

FIG. 8 is a cross-sectional view of the triggering mechanism in FIG. 7.

FIGS. 9-11 are schematics of another exemplary water sampling system of the present invention.

FIG. 12 is a schematic of the water system as provided by an embodiment of the present invention.

### DETAILED DESCRIPTION OF THE INVENTION

Exemplary embodiments of the present invention are now described with reference to the Figures. Reference numerals are used throughout the detailed description to refer to the various elements and structures. In other instances, well-known structures and devices are shown in block diagram form for purposes of simplifying the description. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates generally to a system 100 for collecting water for sampling, and more specifically to system 100 for collecting water for sampling without contamination that includes a triggering mechanism 17, a water sampling device 10, and a pumping mechanism 600. The present invention also relates generally to water sampling device 10 having a removable and sealable container 50 for preventing contamination of sampled water. The present invention also relates generally to a method for collecting water for sampling, the method allowing the collected water to be substantially free from contamination.

The present invention provides a pressure compensated, contamination-free water sampling system using sampling bags that are adapted to function as removable sample containers. The design of the present invention keeps the sampling bag sealed before and after sample water collection. In one embodiment, the disposable bags are filled using a piston “slurp” sampler. When triggered, a spring-loaded piston will draw ambient water into the disposable sample bag. In one embodiment, the water sampling vessel of the present invention mimics the size, shape, and trigger mechanism of standard Niskin or Go-Flo bottles providing interchangeability with standard oceanographic CTD rosette systems. No alterations of existing rosettes, top-side gear, or trigger mechanisms are required when using the water sampling vessel of the present invention. The same number of water sampling vessels of the current invention can be deployed on a rosette, and the rosette can simultaneously accommodate standard sample bottles of the Niskin or Go-Flo type in addition to or intermixed with the water sampling vessels of the present invention. In another embodiment, the disposable bags are filled using an automated pumping mechanism and a bypass or discharge valve. In yet another embodiment, the disposable bags are used in any other water sampling system adapted to receive sampling bags, and are filled by any suitable filling means.

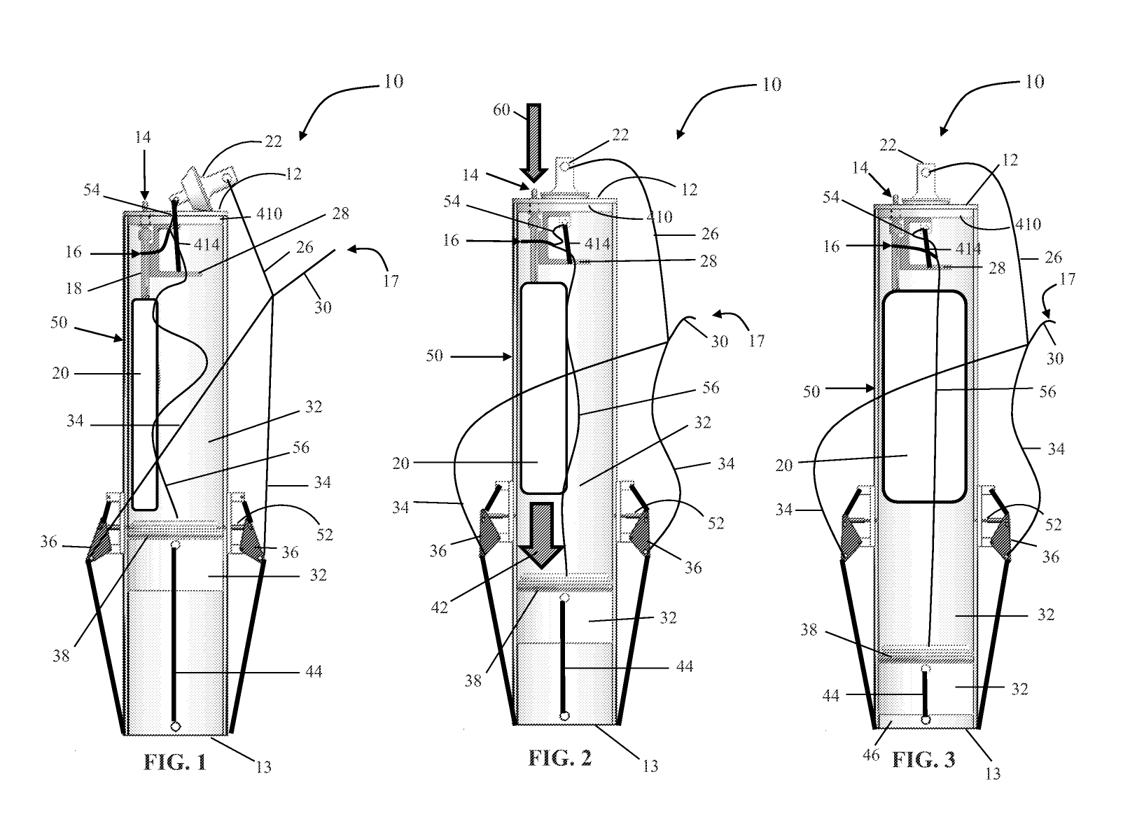

FIGS. 1-3 are schematics of one embodiment of water sampling device 10 and triggering mechanism 17. As discussed above, water sampling device 10 of the present invention can be used interchangeably with existing standard oceanographic CTD rosette systems. In one embodiment, the sampling device 10, is configured such that it is similar to a Niskin bottle or a Go-Flo bottle, so sampling device 10 may be used with existing Rosettes and other existing underwater sampling equipment.

In another embodiment, the dimensions of water sampling device 10 can be varied in height, width, diameter, and/or length depending on the amount of water to be sampled. Water sampling device 10 is generally any water submergible container, and in one embodiment is a generally cylindrical tube having a first end 12 and a second end 13. In one embodiment, second end 13 is opposite first end 12. Water sampling device 10 is constructed from suitable materials, such as, but not limited to, plastics, including polyvinyl chloride (PVC), high density polyethylene (HDPE), or polycarbonate, metals, including aluminum and stainless steel, and other materials that provide adequate structural integrity and can withstand at pressures when submerged to the desired operation depth such as 6096 meters (20,000 feet) or approximately 62.5 MPa (9000 psi).

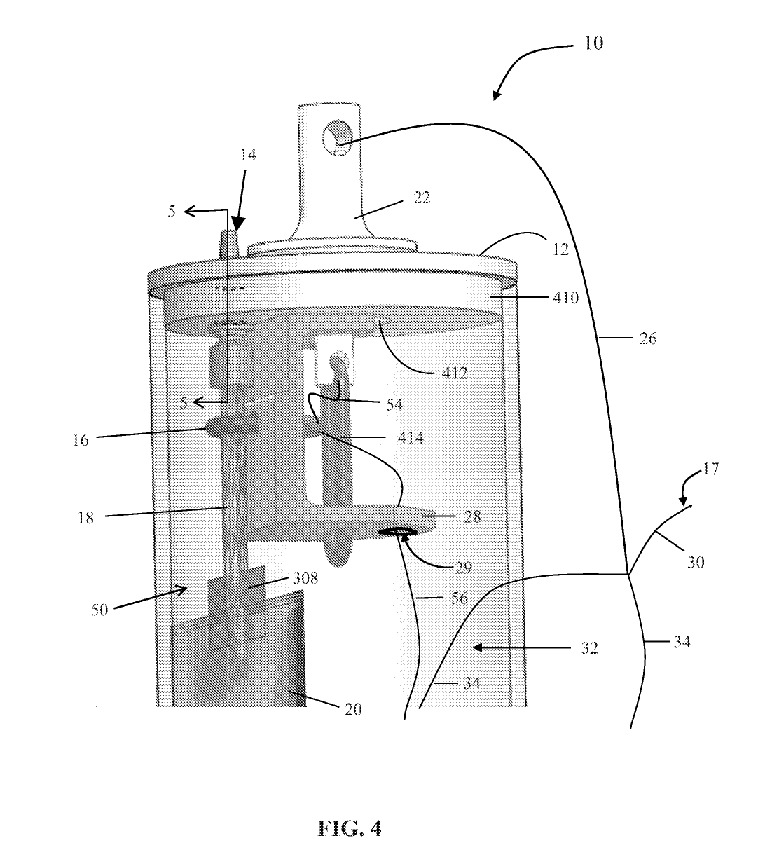

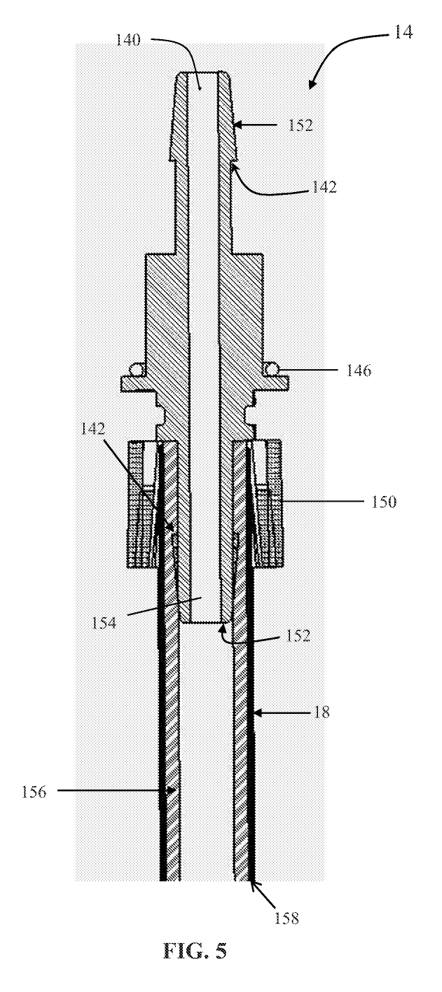

As shown in FIG. 1-4, one embodiment of water sampling device 10 generally includes a piston 38, at least one interior cavity 32, at least one bulkhead 410, and a removable container 50 for holding the water sample inside water sampling device 10. Interior cavity 32 and bulkhead 410 generally hold and protect the interior components and removable container 50 of water sampling device 10. In one embodiment, interior cavity 32 is adjacent to first end 12 of water sampling device 10 or Niskin/Go-Flo type bottle. First end 12 of water sampling device 10 generally includes an upper bulkhead and cap 22 disposed thereon. Bulkhead 410 supports removable container 50 and is closed to the outside except for a cavity opening 412 (see FIG. 4) and an intake port or inlet 14. Inlet 14 is connected to an inlet tube 18 which is connected to sample bag 20. When in an open position, cap 22 allows water to freely flow into interior cavity 32 of water sampling device 10. When in a closed position, cap 22 seals interior cavity 32 of water sampling device 10 and prevents water from moving in or out of interior cavity 32 of water sampling device 10. In one embodiment, cap 22 design is similar to a cap used on a Niskin bottle, which is generally spring-actuated. In another embodiment, cap 22 is similar to the cap used on a Go-Flo bottle, wherein cap 22 includes a ball valve which rotates approximately 180° from its initial closed position, to an open position, to a final closed position.

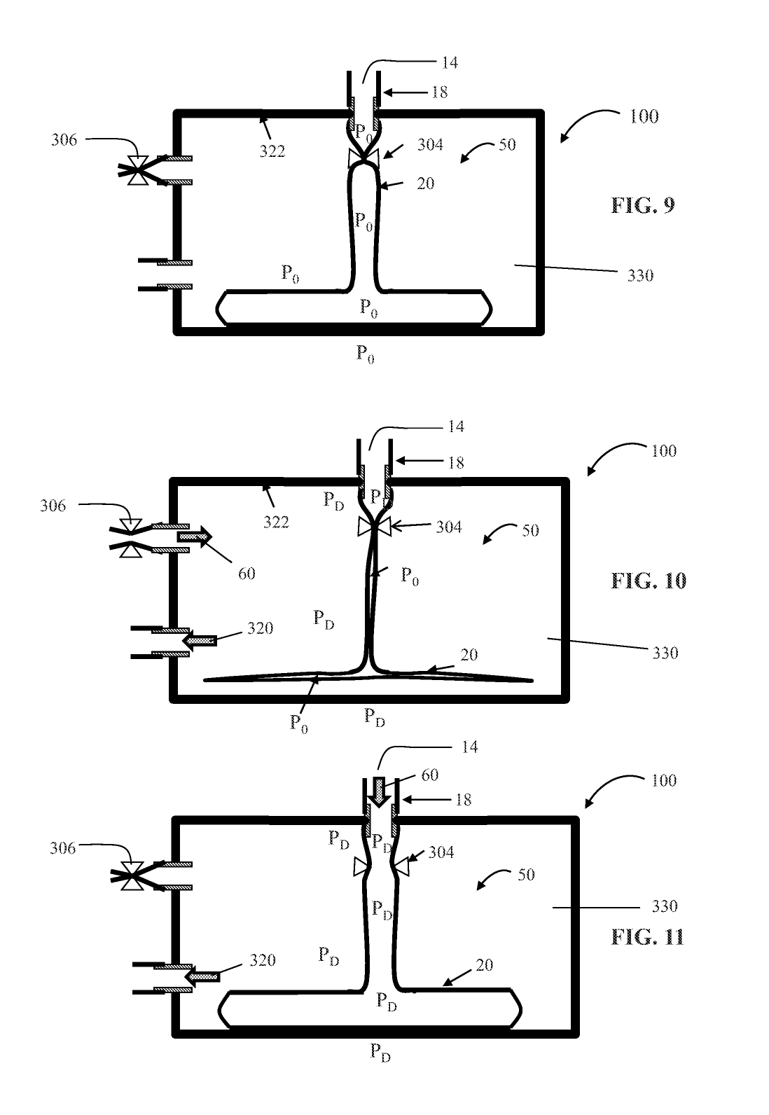

Referring to FIGS. 1-3, removable container 50 of water sampling device 10 includes inlet 14, inlet tube 18, and sampling bag 20. Removable container 50 is generally disposed in water sampling device 10. In one embodiment, removable container 50 is disposed in inner cavity 32 and adjacent to upper bulkhead 410 of water sampling device 10 (see FIG. 1). In another embodiment, removable container 50 is disposed within a “Lung Box” (see FIGS. 9-11).

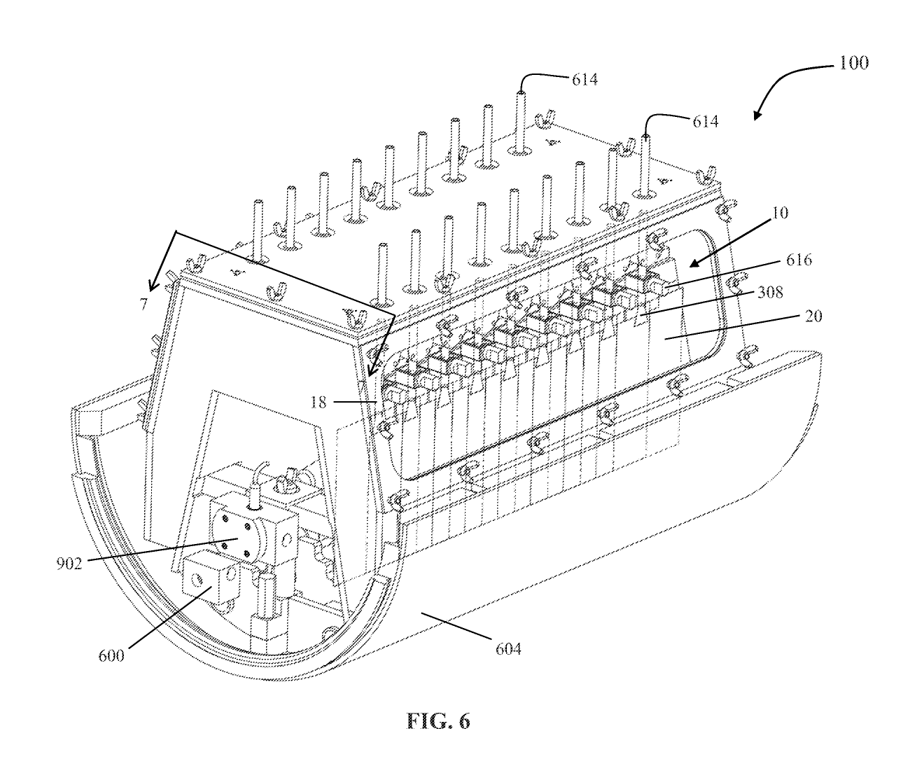

In one embodiment, inlet 14 is constructed from any suitable plastic, such as, but not limited to, nylon, high density polyethylene (HDPE), polypropylene, and natural KYNAR®, or any suitable metal, such as stainless steel, aluminum, and titanium, or any other material that will provide adequate pressure resistance. As shown in FIG. 4, one end of inlet 14 attaches to first end 12 and/or bulkhead 410 of water sampling device 10 and is adjacent to cap 22 and inner cavity opening 412. In one embodiment, inlet 14 is flush with bulkhead 410, in another embodiment, inlet 14 protrudes from bulkhead 410 (see FIG. 6). In one embodiment, a portion of inlet 14 includes a plurality of threads for removably attaching or removably securing inlet 14 into an opening of first end 12 or bulkhead 410 of water sampling device 10.

Referring to FIG. 5, one embodiment of inlet 14 is shown including a hose barb adaptor or compression fitting 152. Inlet 14 includes a first end 140 and a second end 154, both ends 140 and 154 of inlet 14 having hose barb adaptors 152 having hose barbs 142. In another embodiment, inlet 14 is integrally formed as a part of bulkhead 410. In yet another embodiment, inlet 14 is any type of adapter that allows for an adequate connection between inlet tube 18 of sampling bag 20 (see FIGS. 1-4) and the surrounding equipment used for sampling. Suitable examples of adaptors for inlet 14 are, but not limited to, hose barb adaptors 152, threaded hose barb adaptors, T-shaped adaptors having a least one hose barb connection, Y-connectors, quick disconnect fittings, compression fittings or any other suitable connectors. Inlet 14 also includes an o-ring 148 to provide a tight seal between inlet 14 and bulkhead 410. As shown in FIG. 5, inlet tube 18 includes an inner inlet tube 156 and outer inlet tube 158 secured and disposed over hose barb 142 of inlet 14 by a clamp fitting 150. Clamp fitting 150 secures inlet tube 18 to inlet 14. In another embodiment (not shown), inlet 14 is a T-shaped adaptor, including a hose barb. For example, when inlet 14 is secured to a bulkhead adaptor, the diameter of the ends of inlet 14 are generally in the range of approximately 3.175 millimeters (0.125 inch) to approximately 25.4 millimeters (1.0 inch), depending on the desired flow into the disposable sample bag. In another alternative embodiment of the present invention, inlet 14 of removable container 50 further includes an inlet cap or seal to prevent ambient water from entering inlet 14 and inlet tube 18 before the desired sampling time. In this embodiment, a portion of inlet 14 is pre-filled with an inert liquid, such as, but not limited to, water, purified water, seawater, alcohol or bleach before applying the inlet cap, to prevent inlet 14 from crushing during submersion and before sampling. The liquid used to pre-fill inlet 14 is chosen based on the type of material being sampled.

As shown in FIG. 5, inlet 14 is attached to inlet tube 18. Inlet tube 18 includes at least one tube attached to inlet 14 and in another embodiment includes a plurality of tubes. Inlet tube 18 includes outer inlet tube 158 and inner inlet tube 156. Outer inlet tube 158 surrounds and protects inner inlet tube 156 and is generally constructed from a thin film that is water-tight or water-proof, generally non-porous, and generally non-absorbent. Suitable examples of materials for outer inlet tube 158 are, but not limited to, thin film polytetrafluoroethylene (PTFE)(TEFLON®), thin film polyvinyl fluoride (PVF) (TEDLAR®), thin film poly vinyl chloride (PVC), thin film polyvinylidene fluoride (PVDF)(KYNAR®), thin film polyethylene, thin film polypropylene, and combinations thereof. In one embodiment, the thin film of outer inlet tube 158 is approximately 0.0635 millimeters (0.0025 inches) to approximately 0.254 millimeters (0.01 inches) in thickness. In one embodiment, inside diameter of the thin film of outer inlet tube 158 is approximately the same size as the outside diameter of inner inlet tube 156. The outside diameter of outer inlet tube 158 is generally in the range of approximately 4.7625 millimeters (0.1875 inches) to approximately 25.4 millimeters (1 inch) and the inner diameter of the outer inlet tube 158 is generally in the range of approximately 1.5875 millimeters (0.0625 inches) to approximately 22.2250 millimeters (0.875 inches). In one embodiment, outer inlet tube 158 is constructed from the same material as sampling bag 20. In this embodiment, outer inlet tube 158 is attached to or integrally formed with sampling bag 20 by heat sealing or other suitable attachment methods. Other suitable attachment methods include, but are not limited to gluing, ultrasonic welding, and chemically bonding. As shown in FIG. 4, a reinforcement 308, such as adhesive tape or other suitable reinforcement, such as, for example, but not limited to, Kapton tape is applied to sampling bag 20 and a portion of inlet tube 18. The reinforcement 308 provides additional support to the attachment point of inlet tube 18 and sampling bag 20 to reinforce the joint and prevent sampling bag 20 and inlet tube 18 junction or connection from tearing during use or handling.

Referring to FIGS. 4 and 5, inner inlet tube 156 of inlet tube 18 generally transports the water sample to sampling bag 20. Inner inlet tube 156 is generally constructed from a flexible, reasonably springy, and pinch mechanism compatible material. Suitable materials for inner inlet tube 156 generally illustrate softness and resiliency, are chemically compatible with the material to be sampled, have 50-65 Shore A Durometer (ASTM D2240 type A), and low compression set of less than approximately 50% (ASTM D395). Examples of generally suitable materials for the inner inlet tube 156 include, but are not limited to, silicone (TYGON®), fluoroelastomers (VITON®), and other suitable materials. As shown in FIG. 5, inner inlet tube 156 is disposed within and surrounded by outer inlet tube 158 and clamp fitting 150. In one embodiment, inlet tube 18 including inner inlet tube 156 and outer inlet tube 158 is disposed in sampling bag 20 (see FIG. 4). Generally, inner inlet tube 156 has an inner diameter and an outer diameter, in one embodiment, the outer diameter of inner inlet tube 156 is generally in the range of approximately 4.7625 millimeters (0.1875 inches) to approximately 25.4 millimeters (1 inch) and the inner diameter of inner inlet tube 156 is generally in the range of approximately 1.5875 millimeters (0.0625 inches) to approximately 22.2250 millimeters (0.875 inches). In one embodiment, the inner diameter of outer inlet tube 158 is approximately that of the outer diameter of inner inlet tube 156, this minimizes the material to allow pinch mechanism 16 to effectively work on inlet tube 18. The tight fit between outer inlet tube 158 and inner inlet tube 156 provides additional support to thin outer inlet tube 158 to prevent tears or punctures in outer inlet tube 158 during use.

In another embodiment (not shown in the figures), inlet tube 18 is a single tube integrally formed with sampling bag 20 and attached at second end 154 of inlet 14. In this embodiment, the material of inlet tube 18 will generally be that of sampling bag 20. Inlet tube 18 is integrally formed with sampling bag 20 by heat sealing, gluing, ultrasonically welding, or chemically bonding. A layer of strain relief tape or reinforcing material 308 is optionally applied to the attachment point of inlet tube 18 and sampling bag 20 (see FIG. 4).

As shown in FIGS. 1-4, attached to or surrounding inlet tube 18 is closing or pinch mechanism 16. In one embodiment pinch mechanism 16 is a pinch valve, a spring and cam, where the cam is actuated by the spring. In another embodiment, pinch mechanism 16 is a sliding, guillotine style component actuated by a spring. In another embodiment, pinch mechanism 16 is a loop of elastic, spring or bungee that, when tightened by pre-trigger lanyard 56 against mounting bracket 28, squeezes inlet tube 18 against mounting bracket 28 to close inlet tube 18 (see FIG. 3). As shown in FIGS. 1-4, pinch mechanism 16 is attached to mounting bracket or flange 28 and connected to triggering mechanism or system 17 and controls the flow of sample water into sampling bag 20. When pinch mechanism 16 is open, inlet tube 18 is fully open and water is able to freely flow into or out of sampling bag 20. When pinch mechanism 16 is closed, inlet tube 18 is pinched closed and no water is able to flow into or out of inlet tube 18 and into or out of sampling bag 20.

As shown in FIGS. 1-4, removable sampling container 50 includes inlet 14, inlet tube 18, and sampling bag 20. Desirable properties of sampling bag 20 include, but are not limited to, thinness, flexibility, inertness, crushability, resiliency, and resistance to tears and punctures. In one embodiment, sampling bag 20 is removable, reusable, disposable, or any combination thereof. Examples of suitable materials for sampling bag 20 include, but are not limited to, thin film polytetrafluoroethylene (PTFE)(TEFLON®), thin film polyvinyl fluoride (PVF) (TEDLAR®), thin film polyvinylidene fluoride (PVDF) (KYNAR®), thin film poly vinyl chloride (PVC), thin film polyethylene, thin film polypropylene, aluminized Mylar, and combinations thereof. Generally, underwater samples are collected to determine biological or chemical conditions in the water, and the materials used for sampling bag 20 are varied depending on the type of sampling desired or on sampling conditions. The films used to construct sampling bag 20 generally have a thickness of in the range of approximately 0.0254 millimeters (0.001 inches) to approximately 1.587 millimeters (0.0625 inches). Generally, sampling bag 20 is constructed by overlapping the film and heat sealing the edges of the film together to form sampling bag 20. In one embodiment, inlet tube 18 is integrally formed with sampling bag 20 by heat sealing. Sampling bag 20 can also be formed by other suitable bag forming methods, such as, but not limited to molding or blowing. The method used to form sampling bag 20 varies based on the bag material and the thickness of the film used to construct sampling bag 20. As shown in FIG. 1, when sampling bag 20 is initially installed in water sampling device 10, sampling bag 20 is fully deflated. The size of sampling bag 20 can be varied based on the amount of sample water to be collected. In one embodiment, sampling bag 20 can be constructed to hold approximately 200 milliliters (mL) to approximately 10 liters (L) of sample water.

As shown in FIGS. 1-4, one embodiment of water sampling device 10 is Niskin or Go-Flow type water sampling device. Water sampling device 10 includes first end 12, second end 13, sampling container 50, and pinch mechanism 16. Water sampling device 10 also includes at least one inner cavity 32 and mounting bracket 28. Mounting bracket 28 is generally secured to first end 12 or bulkhead 410 of water sampling device 10, by a plurality of screws or other mounting means, including welding. Mounting bracket 28 provides an attachment surface or guide for various components in water sampling device 10, such as, but not limited to, pinch mechanism 16 and various lanyards. First lanyard 54 generally attaches to a portion of pinch mechanism 16 and cap 22. In one embodiment, when water sampling device 10 is in a “pre-triggered” state and cap 22 is open, first lanyard 54 provides tension on pinch mechanism 16 to hold inlet tube 18 closed (see FIG. 1). In the pre-triggered state, triggering lanyard 30 provides tension on cap lanyard 26 and piston lanyards 34. Cap lanyard 26 holds cap 22 in an open position, which in turn also provides tension on first lanyard 54. In the “pre-triggered” state first lanyard 54, provides tension on pinch mechanism, which in turn closes inlet tube 18 of sampling bag 20. Second lanyard 56 generally attaches to a portion of pinch mechanism 16 and piston 38. Second lanyard 56 runs through aperture 29 in mounting bracket 28. Cap 22 includes cap spring 414 configured to connect cap 22 and mounting bracket 28.

After water sampling device 10 has been triggered (see FIGS. 2 and 3), triggering lanyard 30, releases the tension on cap lanyard 26 and piston lanyards 34. Releasing cap lanyard 26 causes cap spring 414 to actuate and causes cap 22 to close and seal inner cavity 32 from water flow. This triggering releases first lanyard 54 holding pinch mechanism 16 in a closed position. Pinch mechanism 16 or pinch valve controls the flow of water into or out of inlet tube 18 and sampling bag 20. When pinch mechanism 16 is opened, water freely flows into inlet 14 and through inlet tube 18 into sampling bag 20. FIG. 4 illustrates one embodiment of inlet tube 18 surrounded by pinch mechanism 16. Embodiments of pinch mechanism 16 may include, but are not limited to, a loop of material to choke inlet tube 18, a cam, or a guillotine style pinch mechanism, pinch mechanism 16 can be actuated by springs, solenoids, servos, motors or other suitable actuation means. Examples of suitable materials for pinch mechanism 16 as a loop are, but not limited to, rubber, latex, or other flexible elastic materials. Examples of suitable materials for pinch mechanism 16 as a pinch valve, are but not limited to, plastics such as acetal, ABS, PVC, Teflon or metals such as, but not limited to, aluminum, stainless steel, copper or titanium.

As shown in FIG. 1, water sampling device 10 is untriggered and cap 22 is in an open position to allow water to freely flow into or out of inner cavity 32 through inner cavity opening 412 (see FIG. 4). The state of the water sampling device 10 shown in FIG. 1 is a “pre-trigger” state. In the pre-trigger state, sampling bag 20 is deflated and does not contain any water or additional air. In the pre-trigger state, piston 38 is in a pre-loaded position and held in place by a plurality of pins 52 and/or a piston release mechanism 36. In the pre-trigger state, cap lanyard 26 holds cap 22 in an open position. In the pre-trigger state, first lanyard 54 provides tension on pinch mechanism 16 thereby closing inlet tube 18.

As shown in FIG. 2, water sampling device 10 has been triggered. In the triggered state triggering lanyard 30 has been released. The release of triggering lanyard 30 generally takes place above the sampling site, usually at the surface on the vehicle from which the water sampling system is deployed, and is generally electronically controlled. The release of triggering lanyard 30 simultaneously releases piston lanyards 34, cap lanyard 26, and first lanyard 54. When cap lanyard 26 is released cap 22 is no longer held in an open position and is closed to prevent water from freely moving in or out of inner cavity 32 of water sampling device 10. In one embodiment, the release of cap lanyard 26, releases first lanyard 56 and pinch mechanism 16. Piston lanyard 34 holds piston pins 52 in place. When piston lanyard 34 is released piston pins 52 and piston release mechanism 36 are released and piston 38 begins to move in a direction toward second end 13 of water sampling device 10. This movement of piston 38 creates a vacuum 42 or lung inside inner cavity 32 of water sampling device 10. Vacuum 42 creates a pressure differential between interior cavity 32 and the exterior water conditions. As a result of vacuum 42, and release of pinch mechanism 16, inlet 14 sucks in water into inlet tube 18 and into sampling bag 20 to equalize the pressure differential between interior cavity 32 of water sampling device 10 and the exterior water.

As shown in FIG. 3, once piston 38 reaches the pre-determined position, second lanyard 56 is actuated. Once second lanyard 56 is actuated pinch mechanism 16 or pinch valve is closed by the tension created by second lanyard 56 pulling on pinch mechanism 16. Once pinch mechanism 16 is closed it pinches inlet tube 18 closed which prevents water from entering or exiting sampling bag 20. In one embodiment, piston 38 moves past ports in the housing. These ports provide a path for water to enter interior cavity 32 without entering sampling bag 20 to relieve vacuum 42 in interior cavity 32 while piston 38 completes its travel toward second end 13 of water sampling device 10. This continued motion without vacuum 42, allows pinch mechanism 16 to close when actuated by second lanyard 56 allowing sampling bag 20 to be sealed under ambient pressure conditions. In one embodiment, water sampling device 10 includes pre-determined position for piston stop, such as, a bar stop 46, a bulkhead, or rod placed in second end 13 of water sampling device 10.

FIGS. 1-3 are schematics of the various stages of the method of collecting contamination free water samples. In one embodiment, the present invention is used with existing Niskin or Go-Flo rosettes (not shown) for sampling. Prior to deploying the rosette, all water sampling devices 10 are loaded with new removable sampling containers 50, removable sampling containers 50 include inlet 14, inlet tube 18 and sampling bag 20. As shown in FIG. 1, pistons 38 are moved to their pre-sampling position and cap 22 is provided in an open position. Cap 22 is held in the open position by cap lanyard 26 which is attached to triggering lanyard 30. As shown in FIG. 1, water sampling device 10 is “ready to trigger.” Water sampling device 10 is then mounted to the rosette and connected to the existing triggering mechanism 17 via triggering lanyard 30, in the same way as a Niskin or Go-Flo bottle is attached to a trigger system. Triggering mechanism 17 used in the present invention, is like that of current electrical or mechanical triggering systems used with standard Niskin bottles and Go-Flo bottles. By using standard triggering mechanisms, the present invention can be used with existing water sampling equipment, thereby reducing the cost. In an alternative embodiment, single water sampling device 10 can be used, incorporating existing electronic or mechanical trigger mechanisms. Upon immersion, the open hole or inner cavity opening 412 (see FIG. 4) in first end 12 or bulkhead 410 allows inner cavity 32 of water sampling device 10 to flood to equalize pressure during descent. As shown in FIG. 1 pinch mechanism 16 remains closed to keep sampling bag 20 of removable container 50 clean and empty until sampling is initiated.

When the sampling depth is reached, the operator fires triggering mechanism 17 in a conventional manner. As shown in FIG. 2, when triggering mechanism 17 causes the release of triggering lanyard 30, a number of simultaneous events occur to begin sampling. As shown in FIG. 2, cap 22 closes inner cavity opening 412 in bulkhead 410, sealing the upper portion or cavity 32 of water sampling device 10 between piston 38 and upper bulkhead 410. At the same time, piston lanyard 34 is released thereby releasing piston pins 52 and piston 38. Once piston 38 is released piston spring 44 pulls piston 38 toward second end 13 of water sampling device 10, thereby creating vacuum 42 inside inner cavity 32, between piston 38 and upper bulkhead 410. Simultaneously, pinch mechanism 16 opens allowing water to enter sampling bag 20 through inlet 14 and inlet tube 18. Water enters sampling bag 20 from outside water sampling device 10 through inlet 14 and inlet tube 18 in upper bulkhead 410 to fill vacuum 42 created by the moving piston 38. A quantity of water equal to the volume displaced by piston 38 will be drawn into sampling bag 20.

As shown in FIG. 3, when piston 38 reaches the end of its stroke, pinch mechanism 16 will close, thereby cutting off the flow between inlet tube 18 and sampling bag 20 and sealing the collected water sample in sampling bag 20.

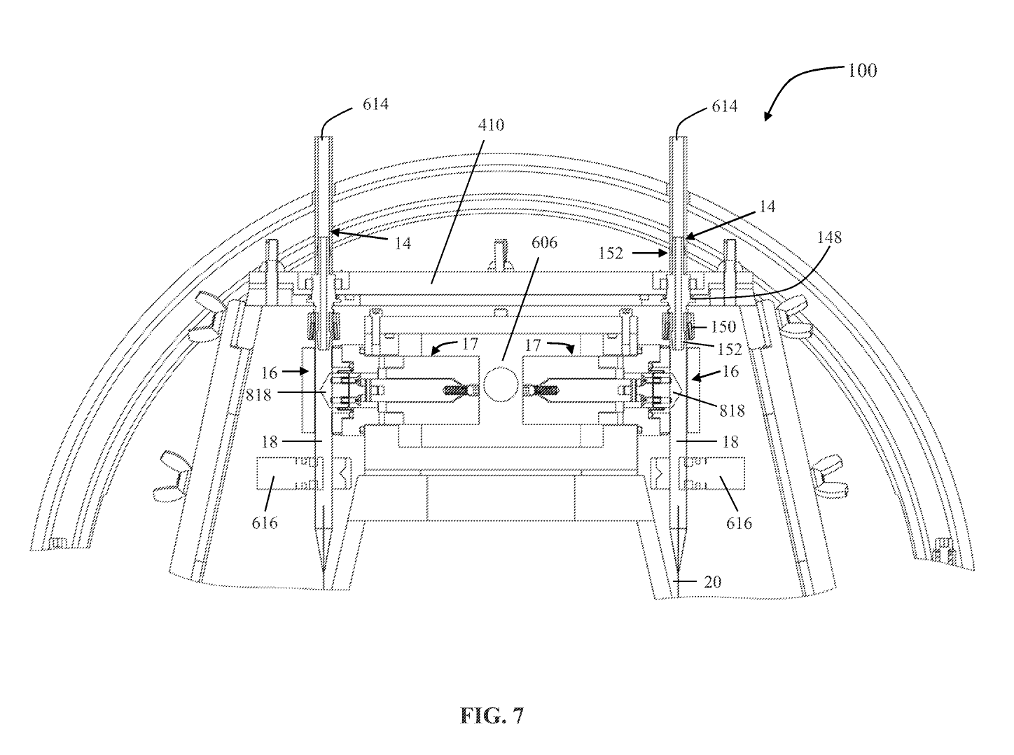

As shown in FIGS. 6 and 7, another embodiment of water sampling device 10 and water sampling system 100 are provided. In one embodiment, water sampling system 100 is a Battelle Autonomous Sampling System (BASS). The BASS is an autonomous water sampler suitable for in situ collection of water for chemical or biological analysis. Water sampling system 100 uses removable sampling container 50 as described above (see FIGS. 1-4). In one embodiment, inlet 14 of removable sampling container 50 is connected to replaceable connector pieces such as tees, extension pieces or other connector pieces connected to a manifold. The tee, extension pieces, and manifold are easily replaceable or disposable, flushable, pressure compensated, and made of inert materials to prevent contamination of the water sample. Suitable materials for the tee and manifold are, but not limited to nylon, high density polyethylene (HDPE), polypropylene, and KYNAR®, or any suitable metal, such as stainless steel, aluminum, and titanium, or any other material that will provide adequate pressure resistance. In one embodiment, pinch mechanism 16 or valve is attached to the BASS sampling device 10 at bulkhead 410 or other suitable location in water sampling system 100. When loading water sampling system 100, inlet 14 and inlet tube 18 of sampling bag 20 are inserted through manual pinch valve 616 and then through pinch mechanism 16, here an open pinch valve 818 or pincher. After the desired location for inlet 14, inlet tube 18 and sampling bag 20 is obtained, pincher 818 is closed, closing off inlet tube 18 and preventing sampling bag 20 from taking in unwanted contaminates or water, prior to sampling.

The BASS sampling system 100 is submersible to any depth and includes a control system. The control system includes a number of electronic components that are programmable to regulate the water sampling rate, water sampling amount, and other functions such as filtering and flushing of the system. In one embodiment the electronic components of the BASS sampling system 100 are housed in a single pressure device that can be designed to meet any depth requirements. In another embodiment, the electronic components are housed in a container with bulkhead 410 where at least a portion of which is flexible, and the container is filled with a dielectric fluid such as, but not limited to, hydraulic oil or mineral oil, to prevent corrosion and salt encrustation of the electrical components while allowing the electrical components to operate at elevated pressure experienced when submerged.

As shown in FIG. 6, water sampling system 100 includes pumping mechanism 600. Suitable examples of pumping mechanisms 600 include, but are not limited to centrifugal pumps, gear pumps, peristaltic pumps, pistons pumps, or other pumping means.

As shown in FIG. 6, the BASS sampling system 100 is “free flooding,” which means it fills with water so the exterior of bulkhead 410 would have water against it. In one embodiment, bulkhead 410 floods by letting water run backwards through a pump while it is off. In another embodiment, a reversible pump is used to pump water into bulkhead 410. In either embodiment, the air in bulkhead 410 would escape out through check valves at the top of bulkhead 410 or through a dedicated valve or port. During sampling, pumping mechanism 600 draws a vacuum to allow water to flow into sampling bag 20 that has been opened by triggering mechanism 17. BASS sampling system 100 includes plurality of inlet extensions 614 that protrude through top cover 602 of water sampling system 100. Inlet extensions 614 are configured to attach to and extend inlet 14 and including any suitable removable, reusable or disposable material.

In one embodiment, triggering mechanism 17 of water sampling system 100 is located in containment box 606. As shown in FIG. 7, electronic solenoid valve 802 is located within containment box 606. Containment box 606 is filled with a pressure compensating fluid. Properties of the pressure compensating fluid include that the fluid is non-conductive, not highly compressible, has a low coefficient of thermal expansion, and has a viscosity similar to water. Examples of suitable pressure compensating fluids are, but not limited to, mineral oil and hydraulic oil.

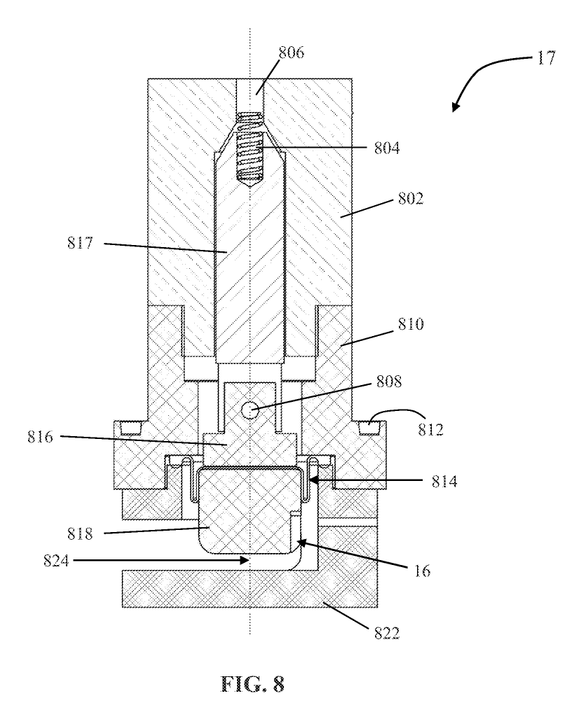

As shown in FIGS. 7-8, triggering mechanism 17, solenoid valve 802 is immersed in pressure compensating fluid, while pinch mechanism 16 and inlet tube 18 remain exposed to the water. As shown in FIG. 8, triggering mechanism 17 includes solenoid valve 802 having actuator 817 (such as a solenoid, motor, servo). Body 810 of triggering mechanism 17 is adjacent to containment box 606 (see FIG. 7) and includes O-ring 812. Actuator 817 creates a rotary or linear movement that, through a linkage, such as through spring 804 and plunger adaptor 816, moves pinch mechanism 16. In one embodiment, spring 804 holds pinch mechanism 16 in a position that pinches inlet tube 18 to obstruct flow through inlet tube 18 when trigger mechanism 17 is off. In one embodiment, spring 804 is adjusted using set screw 806. Actuator 817 is coupled with plunger adaptor 816 by spring pin 808. In one embodiment, pinch mechanism 16 is released such that the squeeze is removed from inlet tube 18 and flow can resume. As shown in FIG. 8, the connection between actuator 817 and pincher 818 can include a flexible membrane or diaphragm 814 that allows actuator 817 and pincher 818 to move but acts as a barrier between the pressure compensating fluid (housing triggering mechanism 17 and electronics) and the surrounding environment. Although not shown in FIG. 8, inlet tube 18 is situated in cavity 824 adjacent to the valve head 822 and pincher 818.

As shown in FIG. 8, diaphragm seal 814 provides a more reliable seal than some other types of shaft seals like dynamic o-ring seals because the sealing surfaces of diaphragm seal 814 are not in motion and perform more similarly to a static o-ring seal or gasket. The shape of diaphragm seal 814 is chosen such that the motion of actuator 817 and pincher 818 causes diaphragm seal 814 to fold and roll and/or stretch. If diaphragm seal 814 shape is chosen such that the predominant allowance for motion is through the rolling of a fold, then it provides a very low friction method of creating a seal with the high reliability of a static seal.

As shown in FIGS. 9-11, an alternative design of BASS sampling device 10 includes Lung Box 322. Lung Box 322 includes at least one valve 306 that allows sea water 60 to flow freely in or out of Lung Box 322. In one embodiment, inlet valve 304 and Lung Box valve 306 are pinch valves, manual valves, or any suitable valves or mechanisms that allow Lung Box 322 and inlet 14 to be opened or closed to water. When Lung Box pinch valve 306 is opened, water sampling system 100 receives water to adjust to pressure changes. Lung Box 322 includes an outlet to a pumping mechanism (not shown). As shown in FIG. 9, located within Lung Box 322 is a single removable sampling container 50; however, multiple removable sampling containers 50 can be located in Lung Box 322. Opening sample valve 304 of sampling bag 20 of removable sampling container 50 fills sampling bag 20 with sample water 60. Generally, inlet 14 of each removable sampling container 50 is exposed to the sampling water.

Lung Box 322 allows for sampling at any depth because it allows system 100 to adjust to the pressure differences between the surface and the sampling depth. As shown in FIG. 9, sampling bag 20 (any number of bags are possible, one is shown for clarity), is disposed within Lung Box 322 and inlet 14 of sampling bag 20 is exposed to ambient water. As shown in FIG. 9, initially at the surface, inlet pinch valve 304 and Lung Box pinch valve 306 are closed and do not allow ambient water or air to flow into sampling bag 20. As shown in FIG. 10, Lung Box 322 is flooded by opening Lung Box inlet valve 306 to allow ambient water to enter cavity 330 of Lung Box 322. At this time, inlet tube 18 of sampling bag 20 is closed because inlet pinch valve 304 is closed. As evidenced in FIG. 10, as a result of sampling bag 20 being closed off from the ambient water, it is compacted by the ambient water flowing into Lung Box 322. In FIG. 10, sampling bag 20 has the same pressure as that at the surface, Pₒ, which causes the sampling bag 20 to crush.

As shown in FIG. 11, to begin sampling water, Lung Box inlet valve 306 is closed and the pumping mechanism (not shown) on Lung Box 322 is actuated, shown by arrow 320. At the same time inlet pinch valve 304 over inlet tube 18 is opened and thereby opening inlet tube 18 and sampling bag 20. The pumping mechanism evacuates water from Lung Box 322 which in turn causes vacuum 42 which pulls water 60 into the sampling bag 20 to account for the pressure difference between the surface and the sampling depth (denoted as P₀ for the original pressure and P_{D} for the pressure at sampling depth). Once the desired amount of sample water is collected the inlet pinch valve 304 is closed. The closed inlet pinch valve 304 seals off the water sample in sampling bag 20. At this time the pumping mechanism is stopped and Lung Box inlet valve 306 is again opened to allow ambient water to flow freely through Lung Box 322. In one embodiment, the pumping mechanism can allow for backward flow in or out of Lung Box 322. The amount of sample collected, is obtainable by various methods, such as for example, but not limited to, a modified flowmeter (in pumped systems), using a specific duration (if flow rate is known), or using a positive displacement pump like a peristaltic or gear pump.

Water sampling devices 10 and water sampling systems 100 of the present invention provide many additional features depending on the desired user configuration. In one embodiment, the BASS sampling device 10 is generally connected to control system 900. Control system 900 is a computer having software to run the various sampling routines and to monitor the various components of water sampling device 10 and water sampling system 100. The software is reconfigurable to match the user's intent. Possible software configurations allow for any valve in the system to be configured to perform any function. Another software configuration allows the sample size and sample type to be user defined. Yet another software configuration allows the user to define the flushing and anti-foulant cycles pre/post sample. The software programming can be done by elapsed time or absolute time and can allow samples to be triggered in the middle of a program. An additional software configuration allows data to be logged with timestamps for later review and comparison to other sensors.

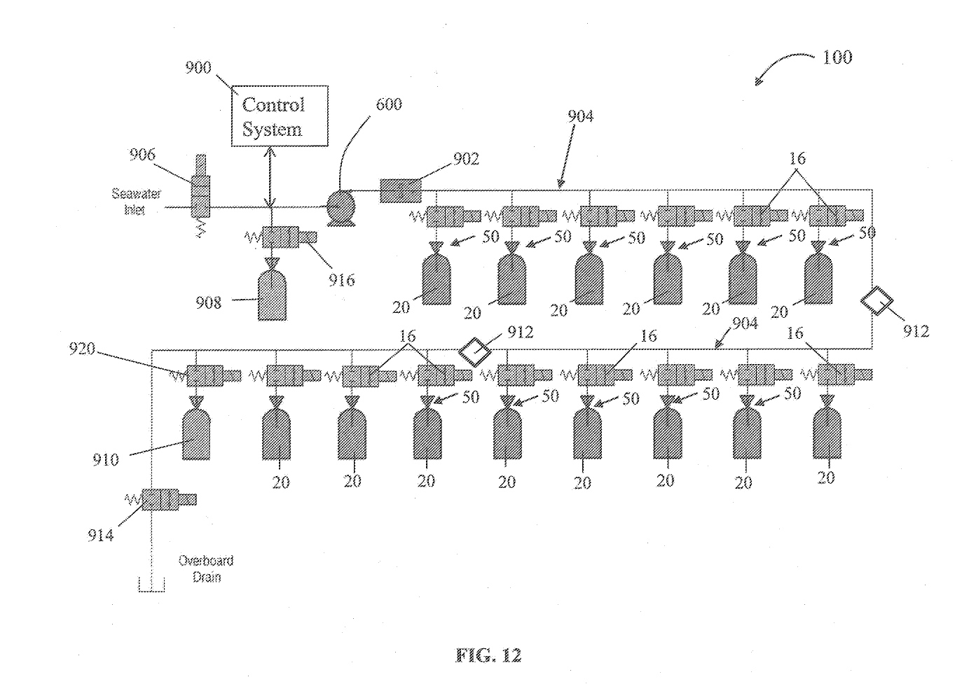

A general system flow schematic of an alternative embodiment of water sampling system 100 is provided in FIG. 12. Water sampling system 100 operates by introducing positive pressure to the system to collect samples, instead of using a vacuum (see FIGS. 1-4, 6-11) to collect samples. To flush water sampling system 100, pumping mechanism 600 is turned on and discharge or bypass valve 914 is left open. During flushing, the water flows though flow meter 902 and past closed sampling bag 20 pinch mechanisms 16 or valves and out discharge valve 914. This allows water to freely flow through water sampling system 100 and clear the manifolds or tubing before sampling. As shown in FIG. 12, to collect a sample, pumping mechanism 600 is turned on, and bypass or discharge valve 914 is closed, and appropriate pinch mechanism 16 or sampling bag valve or valves are opened to fill sampling bag or bags 20.

In another embodiment, water sampling system 100 filters water before sampling. As shown in FIG. 12, filter 912 is placed up-stream or in line with removable sampling container 50 and a plurality of valves are used to control the flow into or out of filter or filters 912 and sampling bags 20 of removable sampling container 50. To collect a sample pumping mechanism 600 is turned on and bypass or discharge valve 914 is closed and the appropriate pinch mechanism 16 or sampling bag valve is opened to fill sampling bag 20.

In another embodiment, sampling system is flushed or cleaned with an anti-foulant or cleaning solution before or after a sample is collected. As shown in FIG. 12, the anti-foulant or cleaning solution is provided in an anti-foulant bag 908 located before pumping mechanism 600. In this embodiment, additional inlet shut down valve 906 is provided to close down entire water sampling system 100 after cleaning or to prevent contamination. During cleaning with anti-foulant, inlet shut down valve 906 is open and water is allowed to flow into water sampling system 100 and discharge valve 914 is closed and the valve 916 to the anti-foulant bag 908 is opened allowing the ambient water and anti-foulant to flow into pumping mechanism 600 and through water sampling system 100. During this process, pinch mechanisms 16 or valves to each sampling bag 20 remains closed. Generally, discharge valve 914 remains closed and valve 920 to waste bag 910 is opened to collect the anti-foulant or waste water. In one embodiment, discharge valve 914 remains open and the anti-foulant or cleaner (if acceptable to dispose) is excreted from water sampling system 100 instead of being collected in waste bag 910. After water sampling system 100 has been cleaned, before or after sampling, it can be safely closed off by shutting inlet shutdown valve 906 which prevents any fouling of the components. After cleaning the system, a sample can be taken as described above.

When water sampling system 100 is retrieved, removable sampling container 50 including sampling bag 20 can be sealed with a clamp or manual pinch valve 616 (see FIGS. 6-7) on inlet tube 18 or plugs or caps on inlet 14 and removed from water sampling device 10 with the water left in sampling bags 20 for transport to a laboratory and storage. Water sampling system 100 allows removable sampling container 50 and sampling bag 20 to remain sealed both prior to, and after sampling thereby eliminating contamination from other layers of water. The present invention eliminates the additional step of having to transfer collected water samples. Being able to handle collected water samples in the closed and sealed removable sampling containers 50 during transport and storage reduces possible sources of contamination involved in transferring water from traditional samplers into other sample containers for transportation and storage.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A water sampling system comprising:
(a) a triggering mechanism;
(b) at least one water sampling device configured to cooperate with the triggering mechanism, the water sampling device including:
(i) a removable sampling container, the removable sampling container being disposed in the water sampling device, the removable sampling container including:
a) an inlet;
b) a inlet tube attached to the inlet, the inlet tube extending from the inlet; and
c) a sampling bag attached to the inlet tube; and
(ii) a pinch mechanism located adjacent to and surrounding the inlet tube and proximate to the sampling bag, wherein the pinch mechanism, in a closed position, prevents water from the inlet from entering the inlet tube and the sampling bag, and wherein the pinch mechanism, in an open position, allows water from the inlet into the inlet tube and the sampling bag; and
(c) a pumping mechanism configured to connect to the water sampling device, wherein the pumping mechanism creates a flow of water in the water sampling device to cause the sampling bag to collect water when the pinch mechanism is in an open position.

2) The water sampling system of claim 1, wherein the triggering mechanism includes at least one lanyard, at least one solenoid, at least one piston, and combinations thereof.

3) The water sampling system of claim 1, wherein the triggering mechanism is electrically connected to the pinch mechanism.

4) The water sampling system of claim 1, wherein the triggering mechanism is mechanically connected to the pinch mechanism.

5) The water sampling system of claim 1, wherein the triggering mechanism is located in a containment box.

6) The water sampling system of claim 5, wherein the containment box includes a pressure compensating fluid.

7) The water sampling system of claim 1, wherein the sampling bag is removable, reusable, disposable or combinations thereof.

8) The water sampling system of claim 1, wherein inlet tube includes an inner tube and an outer tube and at least one fitting.

9) A water sampling device comprising:
(a) a sampling container disposed in the water sampling device, the sampling container including:
(i) an inlet;
(ii) an inlet tube configured to cooperate with the inlet, the inlet tube extending from the inlet; and
(iii) a sampling bag attached to the inlet tube; and
(b) a pinch mechanism adjacent to and surrounding the inlet tube, the pinch mechanism proximate to the sampling bag, wherein the pinch mechanism, in a closed position, is configured to prevent water from the inlet from entering the inlet tube and the sampling bag, and wherein the pinch mechanism, in an open position, is configured to allow water from the inlet into the inlet tube and the sampling sample bag.

10) The water sampling device of claim 9, further including a triggering mechanism.

11) The water sampling device of claim 10, wherein the triggering mechanism is mechanically connected to the pinch mechanism.

12) The water sampling device of claim 9, wherein the triggering mechanism includes at least one lanyard, at least one solenoid, at least one piston, and combinations thereof.

13) The water sampling device of claim 10, wherein the triggering mechanism is located in a containment box.

14) The water sampling device of claim 12, wherein the containment box includes a pressure compensating fluid.

15) The water sampling device of claim 9, wherein the sampling bag is removable, reusable, disposable, and combinations thereof.

16) The water sampling device of claim 9, wherein the pinch mechanism is actuated by the triggering mechanism.

17) A method for sampling contaminated water comprising:
(a) providing a water sampling system, the water sampling system including:
(i) a triggering mechanism;
(ii) at least one water sampling device attached to the triggering mechanism, the water sampling device further including:
a) a removable sampling container further including:
i) an inlet;
ii) an inlet tube extending from the inlet; and
iii) a sample bag attached to the inlet tube; and
b) a pinch mechanism, wherein the pinch mechanism is adjacent to and surrounding the inlet tube, the pinch mechanism proximate to the disposable bag; and
(iii) a pumping mechanism configured to connect to the water sampling device, wherein the pumping mechanism creates a flow of water in the water sampling device to cause the sampling bag to collect sample water;
(b) lowering the water sampling system to a pre-determined depth;
(c) actuating the triggering mechanism to start collecting the water sample;
(d) drawing an amount of water in though the inlet and the inlet valve into the sampling bag; and
(e) closing the pinch mechanism, wherein closing the pinch mechanism prevents water from entering or exiting the disposable sample bag.

18) The method of claim 17, wherein the pinch mechanism is actuated by the triggering mechanism.

19) The method of claim 17, wherein the triggering mechanism is located in a containment box.

20) The method of claim 17 further comprising a control system for actuating the triggering mechanism.
